(19) United States
(12) Patent Application Publication
(10) Pub. No.: US 2001/0010698 A1
(43) Pub. Date: Aug. 2, 2001

(54) RGB laser radiation source

(75) Inventors: Juergen Kraenert, Jena (DE); Thomas Gabler, Kromsdorf (DE)

Correspondence Address: Gerald H. Kiel, Esq., REED SMITH LLP, 375 Park Avenue, New York, NY, 10152-1799, US

(73) Assignee: SCHNEIDER Laser Technologies AG

(21) Appl. No.: 09/775,208

(22) Filed: Feb. 1, 2001

(30) Foreign Application Priority Data
Feb. 2, 2000 (DE) 100 04 412.3

(51) Int. Cl. H01S 3/10

(52) U.S. Cl. 372/23

(57) ABSTRACT

An RGB laser radiation source comprising a first laser radiation source whose first beam (₁) is divided in the infrared wavelength region, wherein the first part thereof is frequency-doubled and green (G) light results and another part thereof is used to generate light of another primary color. It is wherein a second beam (₂) is split in the infrared wavelength region from a second laser radiation source, wherein a first part of the second beam (₂) together with a second part of the first beam (₁) is supplied to a first sum frequency mixing and red (R) light results, and, further, a second part of the second beam (₂) is frequency-doubled. This frequency-doubled beam (₃) together with a third part of the first beam (₁) is supplied to a second sum frequency mixing and blue (B) light results.

### BACKGROUND OF THE INVENTION

a) Field of the Invention

The invention is directed to an RGB laser radiation source which generates red, green and blue light from laser radiation in the infrared wavelength range. The red, green and blue light is to be used particularly for showing color images.

b) Description of the Related Art

Generation of light in the primary colors is known from DE 44 32 029 C2, DE 197 13 433 C1, DE 195 04 047 C1, U.S. Pat. No. 5,740,190 A and EP 0 788 015 A2, all of which use an IR laser whose radiation or frequency-doubled radiation is fed, at least in part, to an optical parametric oscillator (OPO). By means of the signal beam and/or idler beam emitted from the optical parametric oscillator, the light is generated in red, green and blue by the additional steps of sum frequency mixing and/or frequency doubling. U.S. Pat. No. 5,295,143 A describes a three color laser in which two Ti:S lasers are pumped by a frequency-doubled infrared laser. The Ti:S lasers supply the colors red and blue. The frequency-doubled infrared laser supplies green.

### OBJECT AND SUMMARY OF THE INVENTION

The invention provides, in meeting a primary object, a new RGB laser radiation source in which technological expenditure is reduced. Further, the laser radiation is to be generated in the three primary colors with stable quality parameters.

The invention is directed to an RGB laser radiation source comprising a first laser radiation source whose first beam is divided in the infrared wavelength region, wherein the first part of this beam is frequency-doubled and green light results and another part is used to generate light of another primary color.

In a first case, the invention is wherein a second beam is generated and divided in the infrared wavelength region from a second laser radiation source, wherein a first part of the second beam with a second part of the first beam is supplied to a first sum frequency mixing and red light results, and, further, a second part of the second beam is frequency-doubled, this frequency-doubled radiation with a third part of the first beam is supplied to a second sum frequency mixing and blue light results.

In a second case, the invention is wherein a second beam is generated and divided in the infrared wavelength region from a second laser radiation source, wherein a first part of the second beam with the second part of the first beam is supplied to a first sum frequency mixing and red light results, this red light is split, and, further, a second part of the second beam with a part of the red light is supplied to a further sum frequency mixing and blue light results.

In both cases, the first laser radiation source emits light in the wavelength range from 1000 nm to 1100 nm and the second laser radiation source emits light in the wavelength range from 1500 nm to 1600 nm.

According to the state of the art, the first laser radiation source is a solid state laser or a neodymium- (Nd—) or ytterbium- (Yb—)based fiber laser or a diode laser. The second laser radiation source is a solid state laser or an erbium- (Er—) or praseodymium- (Pr—) based fiber laser. In particular, an Nd: YAG laser, Nd: YLF laser or Nd: YO₄ laser is used as solid state laser, and an ER-fiber laser or Er-glass laser or lasers with Er-doped or Pr-doped crystals or diode lasers are used for the second laser radiation source. However, any other type or combination of laser radiation sources can also be used provided it delivers the required matched beam parameters, i.e., matched beam outputs, divergence of laser beams, low noise and a wavelength in the indicated wavelength range.

It is important for efficient frequency conversion that the beam of the first laser radiation source and/or its generated frequency-doubled beam is superimposed with the beam of the second laser radiation source and/or with its generated frequency-doubled beam in a nonlinear medium for sum frequency mixing, wherein both beams overlap at least partially with respect to their geometric dimensions and the phase matching conditions for the nonlinear frequency conversion are met. This nonlinear medium can be a nonlinear crystal or a periodically poled structure.

The lasers are advantageously pulsed lasers, particularly mode-locked lasers supplying individual pulses at a pulse repetition frequency up to the MHz range. Typical pulse repetition frequencies for applications for image display are 100 Hz, 32 kHz or greater than 50 MHz, wherein a pulse width in the range of 0.1 ps to 10 ps should be generated for image presentation. A condition for the use of pulsed lasers consists in that the pulses collide synchronously in the nonlinear medium for sum frequency mixing, i.e., they must coincide or at least partially overlap in geometric and temporal dimensions and there must be phase matching.

The above-mentioned condition for partial overlapping is also met when one laser radiation source works at a first pulse repetition frequency and the other laser radiation source works with an integral multiple or an integral part of the first pulse repetition frequency and the pulses of the two laser radiation sources are made to overlap geometrically and temporally.

The above-mentioned condition for partial overlapping is also met when one laser radiation source is a continuous-wave laser and the other laser radiation source is a pulsed laser.

Both laser radiation sources can also be continuous-wave lasers. With this configuration, the temporal overlap is given automatically.

By means of the invention, it is possible to make do with a comparatively small number of component elements to generate the three primary colors.

When the beam parameters, particularly the output power of the two laser radiation sources, are predetermined, a desired splitting of energy in the individual beam paths can be carried out for generating red, green and blue in the desired intensity ratio by means of splitting mirrors having a determined splitting ratio.

The invention will be described in the following with reference to the drawings.

### BRIEF DESCRIPTION OF THE DRAWINGS

In the drawings:

FIG. 1 shows an RGB laser radiation source with four crystals for wavelength transformation; and

FIG. 2 shows an RGB laser radiation source with three crystals for wavelength transformation.

### DESCRIPTION OF THE PREFERRED EMBODIMENTS

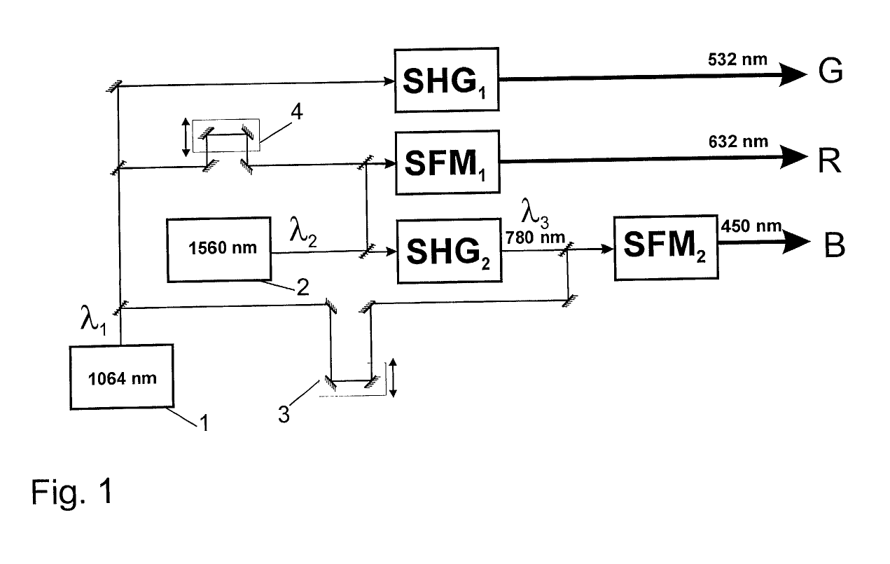

FIG. 1 shows a first construction of an RGB laser radiation source according to the invention. On the one hand, it comprises a first laser radiation source 1 which, in the present example, is a mode-locked Nd-YAG solid state laser. Its first beam λ₁ lies in the infrared wavelength region, 1064 nm in the present example, its pulse width is 4 ps at a pulse repetition frequency of 120 MHz. This first beam μ₁ is split, wherein the first part is frequency-doubled when passing through a first crystal SHG₁ of LBO or KTP or BBO and green light results with a wavelength of 532 nm. Additional parts are used for generating light of primary colors red and blue as will be described in the following. According to the invention, a second beam λ₂ is generated in the infrared wavelength region by a second laser radiation source 2. In the example, this is a mode-locked Erbium- (Er—)based fiber laser. The second beam λ₂ has a wavelength of 1560 nm, likewise with a pulse width of 4 ps at a pulse repetition frequency of 120 MHz.

Further, the second beam λ₂ is also split, wherein a first part of the second beam λ₂ with a second part of the first beam λ₁ is supplied to a second crystal SMF₁ of a first sum frequency mixing in a KTA or LBO or KNbO₃ crystal, so that red light with a wavelength of 632 nm results.

Further, a second part of the second beam λ₂ is frequency doubled in a third crystal SHG₂ and this frequency-doubled beam λ₃ with a wavelength of 780 nm with a third part of the first beam λ₁ is supplied to a fourth crystal SFM₂ of KNbO₃ or KTP or LBO for a second sum frequency mixing, so that blue light with a wavelength of 450 nm results.

The pulses of the two laser radiation sources or their frequency-doubled pulses must correspond to one another in their geometric and temporal dimensions in the nonlinear crystals in which they collide and both pulses must be phase-matched in order to achieve an efficient frequency mixing. For this purpose, the pulse repetition frequency of the pulses of both laser radiation sources is identically set and, if necessary, is held constant by readjusting one of the cavity or resonator lengths. The temporal overlapping of the two pulses is realized by adjusting the optical path lengths in the beam path of one of the laser radiation sources 1 or 2 before the spatial combination of the laser beams in front of each nonlinear crystal in which the sum frequency mixing is realized. For this purpose, in the example, an optical delay 3, 4 is arranged in the beam path of wavelength λ₁ in front of every nonlinear crystal for sum frequency mixing SFM₁ and SFM₂.

Further, the two beams must be superimposed with respect to their geometric extent and orientation in every case within the nonlinear crystal for sum frequency mixing SFM₁ and SFM₂. This is effected by means of the known arrangement of mirrors and lenses in the beam path of the two laser beams with which the sum frequency mixing is carried out. Phase matching of the pulses is achieved by making use of the anistropy of each nonlinear crystal, generally through crystal orientation.

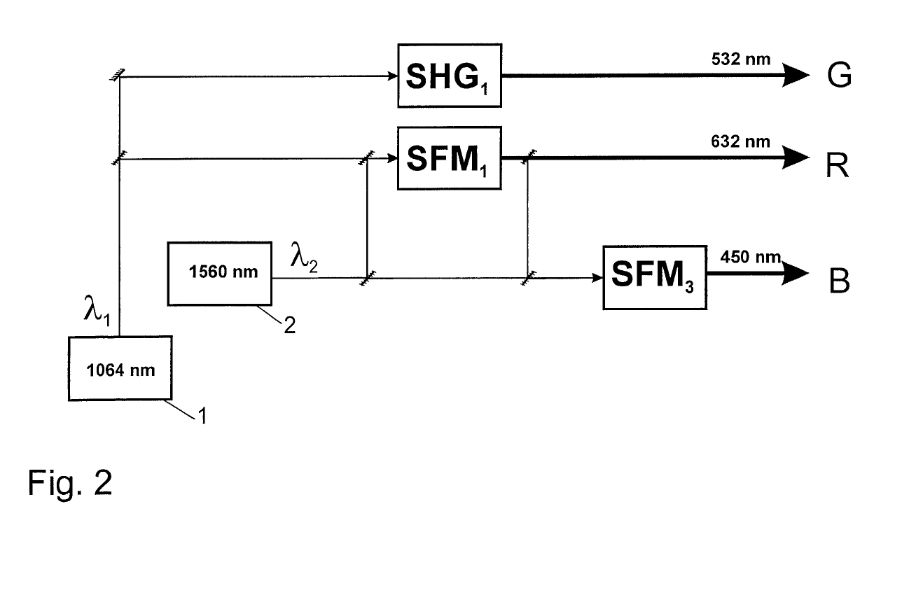

FIG. 2 shows an RGB laser radiation source which works with only three crystals for wavelength transformation. It comprises a first laser radiation source, in the present example, an Nd-based fiber laser, whose first beam λ₁ lies in the infrared wavelength range. This beam is split by a splitting mirror, wherein the first part of the beam is frequency-doubled in the first crystal SHG₁ resulting in green light with a wavelength of 532 nm. The second part is used for generating light of the primary color blue.

According to the invention, a second laser radiation source 2 is provided, whose second beam λ₂ is obtained from an Er-based fiber laser. This second beam is also split by a splitting mirror, wherein a first part of the second beam λ₂ in the infrared wavelength region with the second part of the first beam λ₁ is supplied to the second crystal SMF₁ for the first sum frequency mixing and red light with wavelength 632 nm results.

This red light is split by another splitting mirror. A part of the red light is available for further processing at an output of the RGB laser and the other part is used for generating the color blue. For this purpose, a second part of the second beam λ₂ with one part of the red light is supplied to another crystal SFM₃ of LBO or KNbO₃ for further sum frequency mixing and blue light with a wavelength of 450 nm results. Both lasers are operated as continuous-wave lasers. The nonlinear crystals are constructed in this instance as poled structures.

While the foregoing description and drawings represent the present invention, it will be obvious to those skilled in the art that various changes may be made therein without departing from the true spirit and cope of the present invention.

What is claimed is:

1. An RGB laser radiation source comprising:
a first laser radiation source having a first beam (λ₁) which is divided in the infrared wavelength region;
a first part thereof being provided to a frequency-doubler for producing green (G) light;
another part thereof being used to generate light of another primary color;
a second laser radiation source producing a second beam (λ₂) which is divided in the infrared wavelength region;
a first part of the second beam (λ₂) together with a second part of the first beam (λ₁) being supplied to a first sum frequency mixer for producing red (R) light; and
a second part of the second beam (λ₂) being provided to a frequency-doubler for producing a frequency doubled beam (λ₃), said frequency-doubler beam (λ₃) together with a third part of the first beam (λ₁) being supplied to a second sum frequency mixer for producing blue (B) light results.

2. An RGB laser radiation source comprising:
a first laser radiation source having a first beam (λ₁) which is divided in the infrared wavelength region;
a first part thereof being provided to a frequency-doubler for producing green (G) light;
another part thereof being used to generate light of another primary color,
a second laser radiation source providing a second beam (λ₂) which is divided in the infrared wavelength region;
a first part of the second beam (λ₂) together with a second part of the first beam (λ₁) being supplied to a first sum frequency mixer for producing red (R) light, said red light being split; and
a second part of the second beam (λ₂) together with a part of the red light being supplied to a further sum frequency mixer for producing blue (B) light.

3. The RGB laser radiation source according to claim 1 wherein the first laser radiation source emits light in the wavelength (λ₁) range from 1000 nm to 1100 nm and the second laser radiation source emits light in the wavelength range (λ₂) range from 1500 nm to 1600 nm.

4. The RGB laser radiation source according to claim 3, wherein the beam of the first laser radiation source and/or its generated frequency-doubled beam is superimposed with the beam of the second laser radiation source and/or with its generated frequency-doubled beam in a nonlinear medium for sum frequency mixing, wherein both beams overlap at least partially with respect to their geometric dimensions and the phase matching conditions for the nonlinear frequency conversion are met.

5. The RGB laser radiation source according to claim 4, wherein the laser radiation sources are pulsed and a pulse of the first laser radiation source and/or its generated frequency-doubled pulse and a pulse of the second laser radiation source and/or its generated frequency-doubled pulse collide synchronously in a nonlinear medium for sum frequency mixing.

6. The RGB laser radiation source according to claim 5, wherein one laser radiation source works at a first pulse repetition frequency and the other laser radiation source works with the same pulse repetition frequency or with an integral multiple or an integral part of the first pulse repetition frequency.

7. The RGB laser radiation source according to claim 5, wherein one laser radiation source is a continuous-wave laser and the other laser radiation source is a pulsed laser.

8. The RGB laser radiation source according to claim 4, wherein both laser radiation sources are continuous-wave lasers.

9. The RGB laser radiation source according to claim 2 wherein the first laser radiation source emits light in the wavelength (λ₁) range from 1000 nm to 1100 nm and the second laser radiation source emits light in the wavelength range (λ₂) range from 1500 nm to 1600 nm.

10. The RGB laser radiation source according to claim 9, wherein the beam of the first laser radiation source and/or its generated frequency-doubled beam is superimposed with the beam of the second laser radiation source and/or with its generated frequency-doubled beam in a nonlinear medium for sum frequency mixing, wherein both beams overlap at least partially with respect to their geometric dimensions and the phase matching conditions for the nonlinear frequency conversion are met.

11. The RGB laser radiation source according to claim 10, wherein the laser radiation sources are pulsed and a pulse of the first laser radiation source and/or its generated frequency-doubled pulse and a pulse of the second laser radiation source and/or its generated frequency-doubled pulse collide synchronously in a nonlinear medium for sum frequency mixing.

12. The RGB laser radiation source according to claim 11, wherein one laser radiation source works at a first pulse repetition frequency and the other laser radiation source works with the same pulse repetition frequency or with an integral multiple or an integral part of the first pulse repetition frequency.

13. The RGB laser radiation source according to claim 11, wherein one laser radiation source is a continuous-wave laser and the other laser radiation source is a pulsed laser.

14. The RGB laser radiation source according to claim 10, wherein both laser radiation sources are continuous-wave lasers.
